(19) United States
(12) Patent Application Publication
(10) Pub. No.: US 2026/0016608 A1
(43) Pub. Date: Jan. 15, 2026

(54) Methods and Systems for Measuring Depleted Uranium in Soil Using Mobile Gamma Analysis

(71) Applicants: The United States of America, as represented by the Secretary of Agriculture, Washington, DC (US); Carbon Asset Solutions (USA), Inc., Wetumpka, AL (US)

(72) Inventors: Daniel Donner, III, Winnipeg (CA); Henry Allen Torbert, III, Opelika, AL (US); Stephen A. Prior, Auburn, AL (US); Aleksandr G. Kavetskiy, Auburn, AL (US); Galina N. Yakubova, Auburn, AL (US)

(73) Assignees: The United States of America, as represented by the Secretary of Agriculture, Washington, DC (US); Carbon Asset Solutions (USA), Inc., Wetumpka, AL (US)

(21) Appl. No.: 19/266,696

(22) Filed: Jul. 11, 2025

Related U.S. Application Data
(60) Provisional application No. 63/670,003, filed on Jul. 11, 2024.

(51) Int. Cl. G01T 1/169; G01T 1/167; G01T 1/36

(52) U.S. Cl. CPC G01T 1/169; G01T 1/167; G01T 1/362

(57) ABSTRACT

Systems and methods for detecting depleted uranium contamination in a surface layer of soil comprise: a gamma detector assembly; a location referencing mechanism for detecting a set of geographic coordinates of each location; and a processor in communication with the detector assembly and the location referencing mechanism. The processor is configured to: record each gamma spectrum and the corresponding set of geographic coordinates of each location; calculate a midpoint spectrum between two sequential locations; calculate a number of counts for an energy range of each midpoint spectrum, each calculated number of counts associated with a midpoint location; compare the calculated number of counts to a threshold number of counts representing a number of counts for the energy range of a background gamma spectrum of the surface layer of soil.

### CROSS REFERENCE TO RELATED APPLICATIONS

This application claims the benefit of U.S. Provisional Application No. 63/670,003 filed on Jul. 11, 2024 and entitled “Methods and Systems for Measuring Depleted Uranium in Soil Using Mobile Gamma Analysis,” all of which is incorporated herein by reference.

### TECHNICAL FIELD

The present disclosure relates to systems and methods for detecting elevated levels of depleted uranium in soil.

### BACKGROUND

Uranium is naturally present in soil and produces a background level of soil radioactivity, together with other naturally occurring isotopes such as K⁴⁰ and Th²³². Natural background levels of uranium present in soil has an average concentration of 3 mg/kg (3 ppm) in the Earth's crust, with typical concentrations ranging from 0.3 to 11.7 mg/kg. Although natural background levels of uranium present in soil do not present a concern, the use of depleted uranium in military munitions has been found to greatly increase the levels of uranium in soil, to the point that significant environmental and health risks are being noted.

Naturally occurring uranium consists of three major isotopes, ²³⁸U (99.2739-99.2752% natural abundance), ²³⁵U (0.7198-0.7202%), and ²³⁴U (0.0050-0.0059%). All three isotopes are radioactive (also referred to herein as “radioisotopes”), with ²³⁸U being the most abundant and stable with a half-life of 4.4683×10⁹ years. ²³⁸U is an alpha emitter and decays through an 18-member uranium series into lead-206, as illustrated at FIG. 1A.

Thus, gamma spectrum of uranium ore consists of numerous gamma lines produced by the daughter isotopes of ²³⁸U; primarily, the daughter isotopes ^{234m}Pa, ²¹⁴Bi and ²¹⁴Pb, amongst others. A gamma spectrum of uranium ore, measured by low-level, high-resolution gamma-ray spectroscopy obtained using high purity geranium detectors (herein, “HPGe detectors”) is shown in FIG. 2.

The chemical process for extracting uranium from ore removes all daughter isotopes. The processed ore is referred to as “yellowcake”. The gamma spectrum of freshly produced yellowcake contains virtually no gamma lines. However, 90% of the ²³⁸U decay chain equilibrium with ²³⁴Th, ^{234m}Pa, and ²³⁴Pa occurs in ˜79.9 days. After this period, characteristic gamma lines of these isotopes will reappear in the gamma spectrum of the yellowcake. A gamma spectrum of “yellowcake” measured by HPGe is shown in FIG. 3. As viewed in FIG. 3, characteristic peaks appear at 0.766 and 1.001 MeV, corresponding to the presence of the daughter isotope ^{234m}Pa.

A primary use of uranium is for fuel in nuclear reactors and nuclear weapons. ²³⁵U is fissile and the relative concentration of ²³⁵U needs to be increased for the production of nuclear fuel. Typically, enriched uranium contains 3%-5% of ²³⁵U (as compared to the 0.7% natural abundance of ²³⁵U). A byproduct of this enrichment process is depleted uranium (DU), which is distinguished from natural uranium by a lower concentration of ²³⁵U and ²³⁴U, as ²³⁵U is present in DU at approximately 0.2% compared to 0.7% in unprocessed uranium ore. A gamma spectrum of DU, measured by HPGe, is shown in FIG. 4. Similar to the spectrum for yellowcake shown in FIG. 3, the gamma spectrum for DU shown in FIG. 4 presents peaks at 0.766 and 1.001 MeV that are characteristic of the daughter isotope ^{234m}Pa. However, there is an increase in the noise signal in the gamma spectrum of FIG. 4 as compared to FIG. 3, which may make it more difficult to detect the characteristic peaks of the daughter isotope ^{234m}Pa in the gamma spectrum of a DU sample, as compared to the gamma spectrum of a sample of processed uranium ore.

In military applications, DU is used as a kinetic energy penetrator due to its high density, pyrophoric nature, and a tendency to become sharper as it penetrates armor. Most DU penetrators that strike soft targets (e.g., sand or clay) penetrate the ground and may remain intact for extended periods. However, when a DU penetrator impacts a hard target (such as a military vehicle), typically 10%-35% (up to 70% has been observed) of the material becomes aerosolized and is dispersed into the environment. As a result, DU from munitions can be distributed in the soil in two forms: 1) as a dispersed mixture of fine soil particles and DU acrosols; and 2) as small DU fragments, ranging from millimeters to centimeters in size, scattered throughout the area.

Taking, for example, soils within the continental United States of America, the average uranium concentration is 2.7 μg/g (Shacklette, H. T and J. G. Boerngen. 1984. Element Concentrations in Soils and Other Surficial Materials of the Conterminous United States. USGS. https://pubs.usgs.gov/pp/1270/pdf/PP1270_508.pdf), which does not present an environmental or health threat. However, the presence of DU in agricultural soil above these naturally occurring levels of uranium may lead to uranium contamination of the food supply. Elevated uranium concentrations in food consumed by humans and animals may become toxic above certain thresholds, similar to the accumulation of other heavy metals. As a radioactive material, accumulation of DU in human or animal bodies may cause health problems; however, since radioactivity of DU is greatly reduced compared to natural occurring uranium, the greater risk is the uranium's potential chemical toxicity as a heavy metal, which is about a million times greater in vivo than DU's radiological hazard (U.S. DOI. 2013. “Geochemical and Mineralogical Data for Soils of the Conterminous United States.” USGS Data Series 801. Prepared by D. B. Smith, W. F. Cannon, L. G. Woodruff, F. Solano, J. E. Kilburn and D. L. Frey of the United States Geological Survey. Reston, VA). Uranium may accumulate in several organs (e.g., the liver, spleen, and kidneys), causing damage to these organs over time. Also, like other heavy metals, not all chemical forms of uranium are toxic; specifically, soluble uranium salts cause toxicity. The World Health Organization has established a daily “tolerated intake” of soluble uranium salts for the general public of 0.5 micrograms per kilogram body weight (WHO. 2025. Depleted uranium. htps://en.wikipedia.org/wiki/Depleted_uranium#:˜:text=The%20World%20Health%20Organization%20has,kilograms%20(150%20lb)%20adult).

There is a need for identifying increased uranium concentrations in soil above background levels, particularly in agricultural areas that are impacted by use of DU munitions during armed conflicts. Notable examples of such conflicts include the Gulf War (˜321 tons of DU munitions), the Bosnia-Herzegovina conflict (˜3 tons), and the Kosovo conflict (˜10 tons). More recently, DU munitions have been used in the war between Russia and Ukraine.

Several techniques are available for determining DU concentrations in the environment and for assessing the isotopic composition of uranium in solid compounds. Inductively Coupled Plasma Mass Spectrometry (ICP-MS) may be used, after ashing and chemically digesting samples with concentrated mineral acids. Thermal Ionization Mass Spectrometry (TIMS) is another technique for DU quantification. Alpha Spectrometry may be employed to measure the ²³⁴U/²³⁸U ratio in soil, as demonstrated in studies conducted at military testing ranges in the United Kingdom. High-Purity Germanium (HPGe) detectors may be used to determine uranium activity in environmental samples, particularly when ²³⁸U activity exceeds 1 Bq/kg.

However, all these techniques require sampling, laboratory processing, and long measurement times, taking up to 24 hours. Because DU contamination in the environment, caused by the use of munitions, is often unevenly distributed across large areas, with high concentrations in small, localized zones, intensive sampling, utilizing a small sampling grid across the field, is required to assure that any hotspots are detected. Without very intensive sampling, it is possible that sampling may fail to detect the existence of some areas of DU contamination across a large area. Also, lab analysis of the soil can only detect DU if the DU is contained within the specific soil core sampled in the field. Since fragments of DU are scattered after a battle, the individual fragments may be easily missed in the sampling. The existing processes are therefore both expensive and time-consuming, and may not detect all areas of localized DU contamination.

Therefore, a faster and more cost-effective method is needed to detect concentrated DU contamination across large geographic regions.

### SUMMARY

In one aspect of the present disclosure, a method for detecting depleted uranium contamination in a surface layer of soil in a geographic area is provided. In some embodiments, the method comprises the steps of: moving a system mounted to a mobile platform across the geographic area, the system for acquiring a gamma spectrum at each location of a plurality of locations across the geographic area. The system comprises: a gamma detector assembly for detecting a gamma spectrum of the surface layer of the soil at each location; a location referencing mechanism for detecting a set of geographic coordinates of each location; and a processor in communication with the detector assembly and the location referencing mechanism. The processor is configured to: record each gamma spectrum and the corresponding set of geographic coordinates of each location where the gamma spectrum was recorded; calculate a midpoint spectrum between two sequential locations of the plurality of locations; calculate a number of counts for an energy range of each midpoint spectrum, each calculated number of counts associated with a midpoint location, the midpoint location located midway between the said two sequential locations; compare the calculated number of counts for each midpoint location to a threshold number of counts, the threshold number of counts representing a number of counts for the energy range of a background gamma spectrum of the surface layer of soil, wherein when the calculated number of counts exceeds the threshold number of counts the midpoint location is identified as a location of probable contamination.

In some embodiments of the method, the gamma detector assembly is selected from a group comprising: bismuth germanate scintillation detector assembly, CsI(Tl) scintillation gamma detector assembly, CsI(Na) scintillation gamma detector assembly, LaBr₃(Ce) scintillation gamma detector assembly, CaF2(Eu) scintillation gamma detector assembly, silicon semiconductive gamma detector assembly, germanium semiconductive gamma detector assembly.

In some embodiments, the energy range is selected to encompass at least one characteristic peak of a daughter isotope of uranium in a gamma spectrum of the daughter isotope. In some embodiments, the daughter isotope is ^{234m}Pa and the at least one characteristic peak comprises two characteristic peaks having centroids at 0.766 MeV and 1.001 MeV. In some embodiments, the energy range is from 0.65 MeV to 1.1 MeV.

In some embodiments, the method further comprises a step of generating a map of the geographic area, the map displaying one or more locations of probable contamination. In some embodiments, the map includes one or more contour lines, each contour line of the one or more contour lines defining one or more areas of probable contamination, each area of probable contamination encompassing one or more locations of probable contamination. In some embodiments, the method further comprises a step of surveying each area of the one or more areas of probable contamination to identify locations of depleted uranium contamination.

In some embodiments of the method, the step of moving the system for acquiring the gamma spectrum at each location of a plurality of locations across the geographic area comprises performing a low resolution scan of the geographic area with the system, and wherein the step of surveying each area of the one or more areas of probable contamination comprises performing a high resolution scan of each area of the one or more areas of probable contamination. In some embodiments, the step of surveying each area of the one or more areas of probable contamination is selected from a group comprising: performing intensive sampling and laboratory analysis of each area, performing a search of each area using a meter with a Gaiger-Muller gauge. In some embodiments, the low resolution scan of the geographic area consists of scanning 50% or less of a total surface area of the geographic area, and wherein the high resolution scan consists of scanning 51% or more of a total surface area of the one or more areas of probable contamination.

In some embodiments, the low resolution scan of the geographic area consists of scanning 5% to 50% of the total surface area of the geographic area, and wherein the high resolution scan consists of scanning 70% to 100% of the total surface area of the one or more areas of probable contamination.

In some embodiments, the gamma detector assembly comprises one or more scintillation crystals. In some embodiments, the one or more scintillation crystals comprises at least two scintillation crystals, and the processor is further configured to calibrate an energy of each recorded gamma spectrum detected by each scintillation crystal of the at least two scintillation crystals prior to the step of calculating a midpoint spectrum between two sequential locations of the plurality of locations. In some embodiments, the at least two scintillation crystals consists of three NaI(Tl) crystals having a total volume of more than 7 liters. In some embodiments, the location referencing mechanism is a Global Positioning System (GPS).

In another aspect of the present disclosure, a system for detecting depleted uranium contamination in a surface layer of soil in a geographic area is provided. In some embodiments, the system comprises: a gamma detector assembly for detecting a gamma spectrum of the surface layer of the soil at each location; a location referencing mechanism for detecting a set of geographic coordinates of each location; a processor in communication with the detector assembly and the location referencing mechanism. In some embodiments, the processor is configured to: record each gamma spectrum and the corresponding set of geographic coordinates of each location where the gamma spectrum was recorded; calculate a midpoint spectrum between two sequential locations of the plurality of locations; calculate a number of counts for an energy range of each midpoint spectrum, each calculated number of counts associated with a midpoint location, the midpoint location located midway between the said two sequential locations; and compare the calculated number of counts for each midpoint location to a threshold number of counts, the threshold number of counts representing a number of counts for the energy range of a background gamma spectrum of the surface layer of soil, wherein when the calculated number of counts exceeds the threshold number of counts the midpoint location is identified as a location of probable contamination.

In some embodiments, the gamma detector assembly is selected from a group comprising: bismuth germanate scintillation detector assembly, CsI(Tl) scintillation gamma detector assembly, CsI(Na) scintillation gamma detector assembly, LaBr₃(Ce) scintillation gamma detector assembly, CaF2(Eu) scintillation gamma detector assembly, silicon semiconductive gamma detector assembly, germanium semiconductive gamma detector assembly. In some embodiments, the energy range is selected to encompass at least one characteristic peak of a daughter isotope of uranium in a gamma spectrum of the daughter isotope.

In some embodiments, the daughter isotope is ^{234m}Pa and the at least one characteristic peak comprises two characteristic peaks having centroids at 0.766 MeV and 1.001 MeV.

In some embodiments, the processor is further configured to generate a map of the geographic area, the map displaying one or more locations of probable contamination. In some embodiments, the map includes one or more contour lines, each contour line of the one or more contour lines defining one or more areas of probable contamination, each area of probable contamination encompassing one or more locations of probable contamination.

In some embodiments, the gamma detector assembly comprises one or more scintillation crystals. In some embodiments, the one or more scintillation crystals comprises at least two scintillation crystals, and wherein the processor is further configured to calibrate an energy of each recorded gamma spectrum detected by each scintillation crystal of the at least two scintillation crystals prior to the step of calculating a midpoint spectrum between two sequential locations of the plurality of locations. In some embodiments, the at least two scintillation crystals consists of three NaI(Tl) crystals having a total volume of more than 7 liters. In some embodiments, the location referencing mechanism is a Global Positioning System (GPS). In some embodiments, the gamma detector assembly is housed within a temperature-controlled housing to maintain the gamma detector assembly at a set temperature when performing a scanning operation.

### BRIEF DESCRIPTION OF THE DRAWINGS

FIG. 1A is a schematic diagram illustrating the decay pathway for the radioactive isotope ²³⁸U.

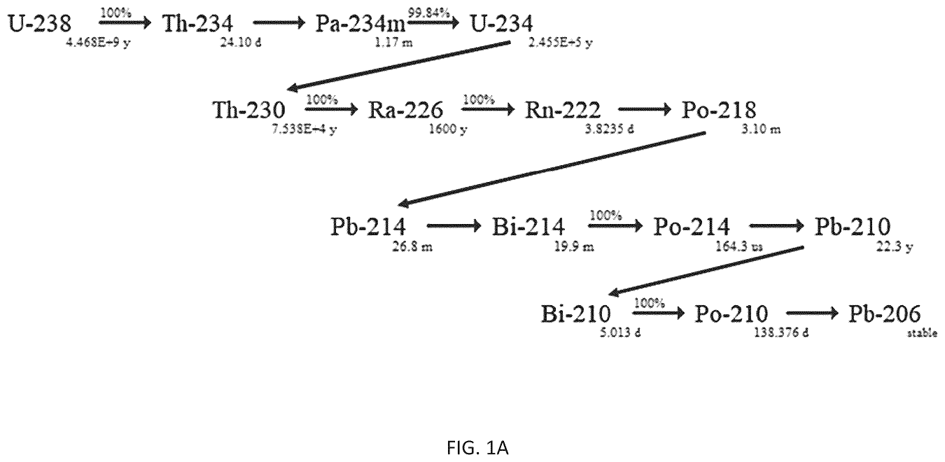

FIG. 1B is a schematic diagram illustrating a sub-branch of the decay pathway for the radioactive isotope ²³⁸U.

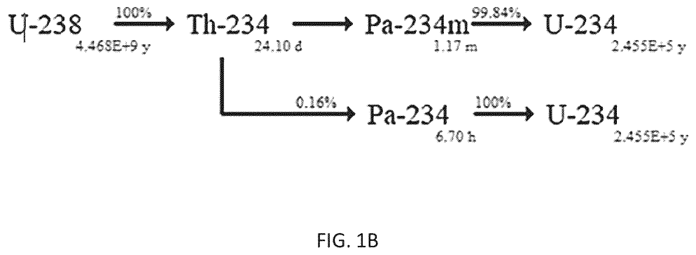

FIG. 2 is a uranium ore gamma spectrum measured by an HPGe detector.

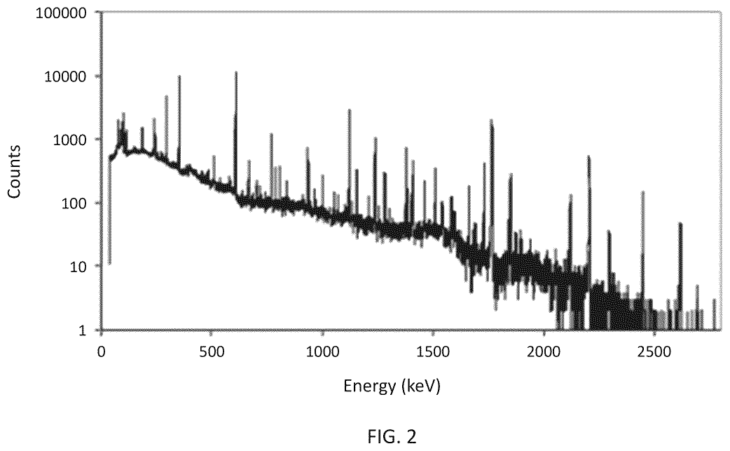

FIG. 3 is a concentrated uranium ore gamma spectrum measured by an HPGe detector.

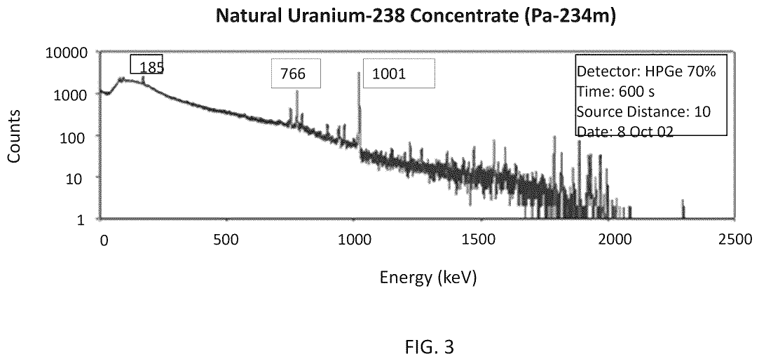

FIG. 4 is a depleted uranium (1 kg, 0.2%) gamma spectrum measured by an HPGe detector.

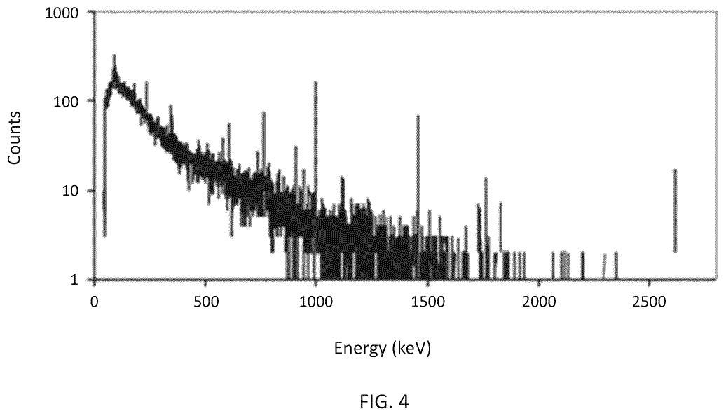

FIG. 5 is a gamma spectrum showing the characteristic peaks of the daughter isotope Bi-214 that is caused by the presence of background levels of ²³⁸U naturally present in the soil, at the Camp Hill location in Alabama, United States of America.

FIG. 6 is an example of raw and shifted gamma spectra of a soil sample obtained by three NaI detectors during background measurements, with the numbers 291, 293, and 294 identifying the individual detectors in the mobile system.

FIG. 7 is an example of a calibration curve for the energy calibration of NaI(Tl) scintillation crystals in a gamma detector assembly.

FIG. 8A is the gamma spectra taken of the natural background radiation of a soil sample, and of a block of DU having the dimensions of 10 cm×10 cm×3 cm, taken with the sample approximately 40 cm from the LaBr₃(Ce) gamma detector.

FIG. 8B is a closeup view of a portion of the gamma spectra shown in FIG. 7A, showing the characteristic DU peaks around 0.766 MeV and 1.001 MeV.

FIG. 9A is the gamma spectra taken of the natural background radiation of a soil sample, and of a block of DU having the dimensions of 10 cm×10 cm×3 cm, taken with the sample approximately 40 cm from the three NaI gamma detectors.

FIG. 9B is a closeup view of a portion of the gamma spectra shown in FIG. 8A, showing the characteristic DU peaks around 0.766 MeV and 1.001 MeV.

FIG. 10 is a plot showing the experimental field measurements and the Monte Carlo N-Particle Transport (MCNP) simulated relative sum of counts in the 0.65-1.1 MeV gamma spectra energy range of a DU block (5.95 kg) buried in soil versus the burial depth of the DU block.

FIG. 11 is a plot of the experimental field measurements and the MCNP simulated relative sum of counts in 0.65-1.1 MeV gamma spectra energy range of a DU block (5.95 kg) laying on the soil surface versus the distance between the DU block and the gamma detector assembly projection point on the soil surface and the inversible square law approximating these dependencies.

FIG. 12 is a plot of the boundary of full gamma ray attenuation in soil, the boundary of the usable gamma ray signal, the inverse square law, and the boundary of the conical soil volume used for the MCNP simulations.

FIG. 13 is a plot of the MCNP simulated gamma spectra of a DU block weighing 5.95 kg, a DU fragment weighing 20 g, and a conical soil volume having a height of 30 cm and a base diameter of 190 cm, the conical soil volume containing 114 g of distributed DU.

FIG. 14 is a graph showing the number of counts in the acquired gamma spectra occurring in the range between 0.65 and 1.1 MeV, for different midpoints across a field where the average of two adjacent gamma spectra that are adjacent to the midpoint was calculated.

FIG. 15 is a map of a laboratory field plot, with the contour lines indicating the areas on the field where the highest counts in the acquired gamma spectra occurring in the range between 0.65 and 1.1 MeV, as shown in the graph of FIG. 9, were located.

FIG. 16 is a perspective view of an embodiment of an MGA system, with the gamma detector assembly of the MGA system contained within a temperature-controlled housing.

### DETAILED DESCRIPTION

As described, for example in Unites States U.S. Pat. Nos. 11,397,277 and 12,031,928, which documents are incorporated in their entirety herein by reference, systems and methods have been developed for analyzing the content of at least one element in the soil of a field by detecting and analyzing gamma spectra obtained from soil samples distributed across a field using a mobile cart. In some embodiments, the mobile gamma analysis (MGA) system may have NaI gamma detectors with a total volume of approximately 7.4 L, providing an MGA system with a relatively high detection sensitivity.

Potassium-40 is an example of a radioisotope that is present in the soil and which produces characteristic peaks in a gamma spectrum. When a gamma spectrum of a soil sample is passively acquired, without irradiating the soil, the acquired gamma spectrum results from the gamma radiation produced by the radioisotopes naturally present in the soil. The presence of natural radioisotopes, such as Potassium-40, has previously been quantitatively analyzed using such MGA systems.

### Detecting Presence of Depleted Uranium Using Passive Gamma Spectra Measurements

In some embodiments of the present disclosure, the detection of uranium contamination caused by the presence of DU in soils may be accomplished based on gamma peak measurements obtained from passively acquired gamma spectra, with the gamma peaks characteristic of the daughter isotopes that are produced by the natural decay of uranium isotopes present in DU. For example, gamma peaks having centroids at 1.001 MeV and 0.766 MeV, respectively, are attributed to the presence of the daughter isotope ^{234m}Pa, which is a product of the decay chain equilibrium produced by the isotope ²³⁸U. For the purpose of detecting the presence of uranium in soil, the increased intensity of gamma ray peaks having centroids at 1.001 MeV and 0.766 MeV, respectively, may be attributed to the uranium decay of DU that is present in the soil, beyond the natural background gamma radiation produced by ²³⁸U that may be naturally present in the soil. For example, the increased intensity of the gamma ray peaks that are attributed to the daughter isotope ^{234m}Pa, may be at least two times greater than the background peak areas of the same characteristic peaks.

In such embodiments, the characteristic peaks of daughter isotope ^{234m}Pa are particularly useful for detecting the presence of DU as compared to the peaks in a gamma spectrum generated by background levels of ²³⁸U that is naturally present in the soil. This is because naturally present ²³⁸U in the soil will produce a gamma spectrum with many characteristic peaks of the eighteen daughter isotopes of ²³⁸U, which daughter isotopes are present in varying amounts after billions of years of radioactive decay of ²³⁸U. In contrast, when processing uranium ore to produce yellowcake, this process removes the daughter isotopes produced over billions of years by the ²³⁸U present in the natural uranium ore, and thus the daughter isotopes are also absent from the DU that is a by-product of the uranium ore processing. However, after a period of a few months or years, the decay of the ²³⁸U that is present in DU will produce the daughter isotopes Th-234 and ^{234m}Pa in detectable quantities. Both Th-234 and ^{234m}Pa are relatively unstable, with half-lives of 24.1 days and 1.17 months, respectively, whereas the half-life of daughter isotope U-234 is relatively stable (more than 245,000 years). Thus, the characteristic peaks of daughter isotope ^{234m}Pa in a measured gamma spectra of a soil, where DU is present, may be expected to increase in detectable amounts, as compared to the characteristic peaks of daughter isotope ^{234m}Pa and other daughter isotopes that result from background levels of ²³⁸U that is naturally present in the soil.

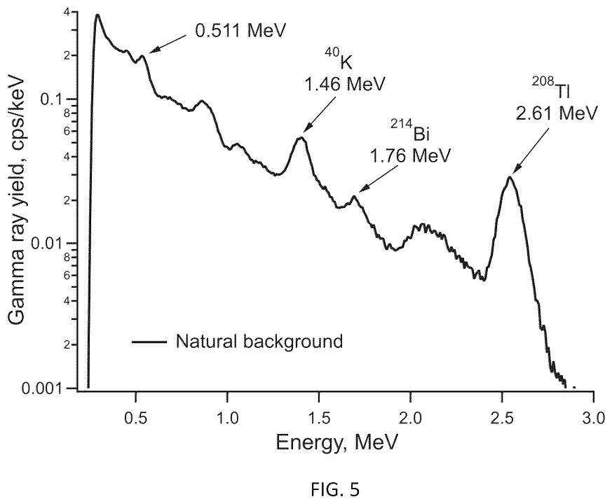

In contrast to soils that are contaminated with DU, an example of the natural background gamma spectrum measured by MGA at the Camp Hill location in the United States, which site is not contaminated with DU, is shown in FIG. 5. Estimates of naturally-present uranium may be obtained through detection of the peaks at 1.76 MeV, which is characteristic of ²¹⁴Bi, a daughter isotope in the ²³⁸U disintegration series. This line is present in the gamma spectra containing background levels of naturally present uranium.

At a site contaminated with DU, the Applicant postulates that a signal increase, of at least double, would occur at 1.001 MeV and 0.766 MeV which are characteristic peaks of the daughter isotope ^{234m}Pa, as compared to a gamma spectrum of a site that is not contaminated with DU. Whereas, the peak value of 1.76 MeV, resulting from the daughter isotope ²¹⁴Bi, should stay approximately the same at a site contaminated with DU, as compared to a gamma spectrum taken of a site that is not contaminated with DU.

### Selecting A Gamma Detector

To test passive gamma spectra measurements for the detection of DU in a soil, two mobile gamma analysis (MGA) systems were tested, with one system having Lanthanum Bromide LaBr₃(Ce) scintillator crystals in the gamma detector assembly, and the other system having Sodium Iodide NaI(Tl) scintillator crystals in the gamma detector assembly. The Lanthanum Bromide LaBr₃(Ce) detector assembly utilized “Scintiblock89 S 203/3.5/B380” (Saint-Gobain Ceramics & Plastics, Inc., Hiram, OH) components, with scintillator crystal sizes having a diameter of 8.9 cm and a height of 20.32 cm, having an approximate total volume of 1264 cm³, paired with an AS20 type voltage divider. This detector is integrated with one channel of a four-channel digital pulse processor for detecting radiation in desktop format with an integrated Linux operation system, Pixie-Net device (XIA, LLC, Oakland, CA) to perform high-resolution gamma ray spectroscopy. This system provides for real-time data acquisition of date produced by the Pixie-Net, which captures counts across multiple energy channels (multi-channel). A software program processes this multi-channel analyzer data to extract and visualize the distribution of gamma ray intensities across these channels.

The MGA system may be installed on a mobile platform that may be towed through fields using a tractor, truck, utility vehicle or any other suitable vehicle, the vehicle travelling at speeds of up to 10 km/hr. In some embodiments, the MGA system may be mounted to a mobile platform that is a drone, with the drone travelling across and taking measurements of the field. The dimensions of the mobile system, in one example embodiment, may be 75 cm×23 cm×95 cm and may weigh ˜300 kg. The system may comprise a power subsystem, gamma spectra measurement equipment (including the gamma detector assembly), a location referencing mechanism, including for example a Global Positioning System (GPS), and an operational computer loaded with software for acquiring and recording gamma spectra measurements and for performing calculations on the acquired gamma spectra. The power subsystem may have four DC105-12 batteries (12 V, 105 Ah), a DC-AC inverter (such as, a CGL 600W-series™; Nova Electric, Bergenfield, NJ), and a model PS4 Quad Pro Charger (PRO Charging Systems™, LLC, LaVergne, TN) to provide autonomous power, for example, for at least 20 hours. Although the location referencing mechanism referred to herein may be a GPS, it will be appreciated by a person skilled in the art that any other means for determining the geographic coordinates of the system, at the location where a gamma spectra is recorded, may also be used and is included in the scope of the present disclosure. For example, the system may be configured to detect and record flags or other markers placed at known locations throughout the field; as another example, the system may be programmed to follow a pre-determined path, and correlate positions along the path with recorded gamma spectra.

Optionally, the gamma detector assembly may be housed in a sealed, temperature-controlled housing with a thermostatically controlled heating/cooling unit to maintain the temperature of the gamma detector assembly at a constant or substantially constant, selected temperature or within a small temperature range. For example, at 23° C., or any other suitable temperature for operating the gamma detector assembly while avoiding the shifting in the spectrum that may otherwise occur if the scanning operation is being performed with fluctuations in the ambient temperature.

In one embodiment of the MGA system, the gamma spectra measurement equipment included a gamma detector assembly comprising three 12.7 cm×12.7 cm×15.2 cm NaI(Tl) scintillation detectors (Model V127AS152/5M-HV-Q-X™ with built-in Cockcroft Walton™ type PS1822/5 high voltage power supply and MOLEX™ connector; Scionix USA, Orlando, FL). The volume of each scintillation crystal is approximately 2452 cm³ and the total volume of the detection array of three scintillation crystals is approximately 7355 cm³ (approximately 7.4 L). The Cockcroft-Walton™ type high voltage power supply may provide high output linearity of gamma detector photomultiplier tubes while maintaining low power consumption by detectors. The electronics board (Vega-microDXP™; XIA LLC, Oakland, CA), connected to the detector by MOLEX™ connector, had a detector voltage-operated module, fixed analog gain, analog-to-digital converter (14-bit resolution, 100 MHz sampling rate), and a 2048-channel multichannel analyzer (for each detector). This board may be used to acquire and transfer gamma spectra to the operational computer. The software on the operational computer set the detector high voltage and electronic board parameters and recorded the acquired spectra at desired intervals (for example, at time intervals in the range of 15 seconds to 30 seconds). A GPS system (Trimble Nav900™ Receiver; Trimble Inc., Westminster, CO) with an accuracy of ±0.5 m, connected to the operational computer, for example, wirelessly via Bluetooth™, identified and recorded the geographic position of each acquired gamma spectrum as the MGA system travelled across the field.

During experiments using this system, spectral data for each detector and the geographic coordinates of the MGA system were recorded at a set time interval, for tests conducted in both scanning mode and static mode. Each record (r) of raw data (for the i-th detector, i=1, 2, 3 detector number) included the following: measured gamma spectra S_{r,i}(Chₘₑₐₛ), which are the number of counts in the channel (cnt/ch) versus channel number (Chₘₑₐₛ) in the multichannel analyzer; real time of spectra acquisition (RT_{r,i}, s); input (absorbed by detector) and output (recorded in spectra) gamma ray count rates (ICR_{r,i}, OCR_{r,i}, cps); clock time of recording of the spectra; and GPS coordinates.

### Calibration of Gamma Detector Arrays Having Two or More Scintillation Crystals

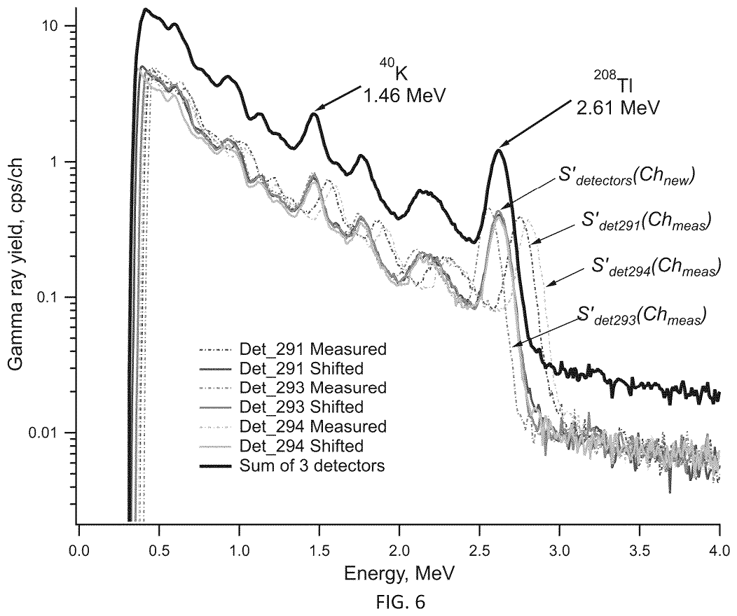

In some embodiments, the gamma detector array may have two or more scintillation crystals; an example of such a gamma detector array, described herein, is a gamma detector array having three NaI(Tl) crystals. In such embodiments, each scintillation crystal may have a slightly different energy calibration, which is the correlation between the photon energy and the channel number. The energy calibration of each scintillation crystal may vary from day-to-day, due to changing environmental conditions (primarily, changes in temperature). Thus, the positions of peak centroids in the acquired spectra do not coincide, as shown by the broken line plots in FIG. 6. Therefore, the acquired spectra of each scintillation crystal in the gamma detector assembly may need to be shifted, so as to correspond to one single energy calibration, prior to adding up the counts of each acquired spectrum within an energy range across the channels.

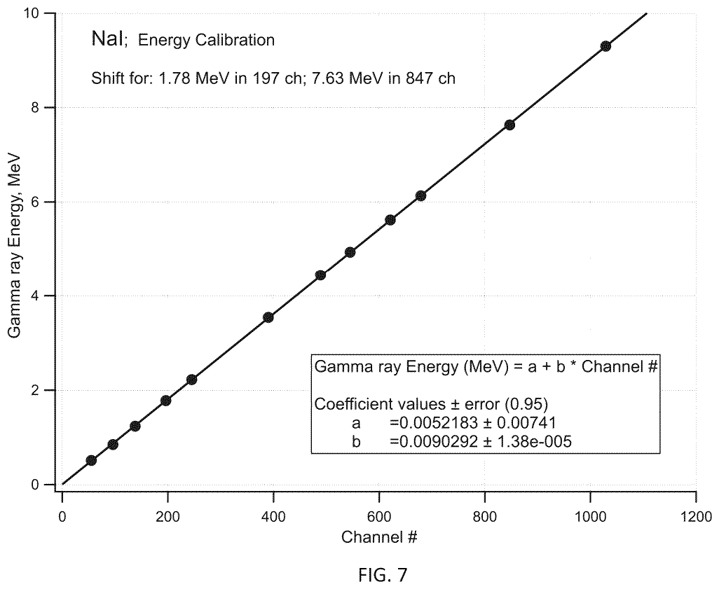

To achieve identical energy calibration of the two or more scintillation crystals, in some embodiments the energy calibration for a reference detector of the same type may be established under laboratory conditions. To accomplish this, several known gamma lines in the natural background gamma spectra and in the gamma spectra of reference gamma sources (⁶⁰Co: 1.17MeV, 1.33 MeV, 2.50 MeV, ¹³⁷Cs: 0.667 MeV) may be used. These known gamma line positions (in the channel number) may be used to create an energy calibration curve for the reference detector; the resulting calibration curve may be a straight line within the energy range of interest, as shown for example in FIG. 7. Spectra measured by other gamma detector assemblies, of the same type and measured under different environmental conditions, may be brought to the created calibration line by utilizing a shifting procedure, for example, using Igor Pro™ software. Using this procedure, channel numbers of two well-identified peaks, Ch_{1,meas} and Ch_{2,meas}, in each measured S(Chₘₑₐₛ) spectrum are defined. In the example of taking gamma spectra measurements for the detection of DU, the peaks with centroids at ε₁=2.61 MeV of ²⁰⁸Tl, and ε₂=1.46 MeV of ⁴⁰K (see FIG. 6), taken from well-established data based on natural background spectra of soils, were used for the calibration procedure to shift the acquired spectra of each scintillation crystal of the three NaI(Tl) crystals used in an embodiment of the gamma detector assembly. In some embodiments, this calibration correction may be applied by the software, for the calibration of each crystal of the two or more scintillation crystals utilized in an MGA system.

Next, channels of acquired spectra (Chₘₑₐₛ) are shifted to a new position (Ch_{new}) according to the following equations:

$${Ch}_{new} = Int [ X ( C {h}_{meas} ) ] , \qquad ( 1 )$$

where “Int[]” is an integer function which rounds a number down to the nearest integer,

$$X ( {Ch}_{meas} ) = \frac{{d}_{ref} - {d}_{meas} + {b}_{ref} \cdot {Ch}_{meas}}{{b}_{meas}} , \qquad ( 2 )$$

$${d}_{ref} = {ε}_{1} - {b}_{ref} \cdot {Ch}_{1 , ref} , \qquad ( 3 )$$

$${d}_{meas} = {ε}_{1} - {b}_{meas} \cdot {Ch}_{1 , meas} , \qquad ( 4 )$$

$${b}_{ref} = \frac{{ε}_{2} - {ε}_{1}}{{Ch}_{2 , ref} - {Ch}_{1 , ref}} , \qquad ( 5 )$$

$${b}_{meas} = \frac{{ε}_{2} - {ε}_{1}}{{Ch}_{2 , meas} - {Ch}_{1 , meas}} , \qquad ( 6 )$$

Wherein, Ch_{1,ref} and Ch_{2,ref} are the channel numbers for energy ε₁ and ε₂ in the reference calibration line; b_{ref} is the MeV/channel for calibration reference data; bₘₑₐₙ is the MeV/channel for the measurements; d_{ref} are defined as a “zero” shift (ie: the energy calibration line does not pass through the 0,0 coordinates); and dₘₑₐₛ are the differences between the energy of the calculated reference and the measured values. Count numbers in the channel with the new channel number S(Ch_{new}) are calculated as:

$$S ( {Ch}_{new} ) = S ( {Ch}_{meas} ) - S ( {Ch}_{meas} ) \cdot \{ X ( {Ch}_{m e a s} - 1 ) - Int [ X ( {Ch}_{meas} - 1 ) ] \} + S ( {Ch}_{meas} + 1 ) \{ X ( {Ch}_{meas} ) - Int [ X ( {Ch}_{meas} ) ] \} , \qquad ( 7 )$$

The shifted spectra of each detector S_{r,i}(Ch_{new}) is calculated in cps/ch as:

$${S}_{r , i}^{′} ( {Ch}_{new} ) = \frac{{S}_{r , i} ( {Ch}_{new} )}{{LT}_{r , i}} , \qquad ( 8 )$$

where

$${LT}_{r , i} = {RT}_{r , i} \cdot \frac{{OCR}_{r , i}}{{ICR}_{r , i}} . \qquad ( 9 )$$

The sum of the three detector spectra for each r-th record, S′ᵣ(Ch_{new}), in cps/ch, may then be calculated as:

$${S}_{r}^{′} ( {Ch}_{new} ) = {\sum }_{i = 1}^{3} {S}_{r , i}^{′} ( {Ch}_{new} ) \qquad ( 10 )$$

The summed gamma spectra, taken from the shifted gamma spectrum produced by each of the three detectors 291, 293 and 294, is shown in the plot of FIG. 6. The sum of shifted spectra is used in the next data processing steps for detecting DU from the acquired gamma spectra, and for the calculation of the minimum detection limit (MDL) of DU as determined by the methods of passive gamma spectra analysis disclosed herein.

It may be noted that in some embodiments, the inclusion of two or more scintillation crystals in a gamma detector assembly may always require that calibration be applied to bring all of the crystals in the detector assembly to the same energy calibration, as described in detail above. It will also be appreciated that the shifting of acquired gamma spectra that may occur, as a result of subjecting the crystals of the gamma detector assembly to temperature fluctuations, is a separate issue from the need to bring multiple crystals to the same energy calibration, as described above. In some embodiments, it will be appreciated that utilizing environment-controlled housing for the gamma detector assembly on the MGA system, to maintain the scintillation detector crystals, such as NaI(Tl) crystals used in the above-described system, at a relatively constant temperature, or within a small temperature range, to reduce shifting of the acquired gamma spectra that may otherwise occur if the gamma detector assembly is subject to temperature fluctuations. The optional use of temperature-controlled housing, to reduce or eliminate shifting of the gamma spectra that may otherwise occur when the gamma detector assembly is subjected to ambient temperature fluctuations, is described below. Such temperature-controlled housing may be used with a gamma detector assembly having any type of scintillation crystal, and is not limited to the example of the gamma detector assembly incorporating three NaI(TI) crystals.

### Temperature-Controlled Housing

In some embodiments of the MGA system, the system includes a temperature-controlled housing for housing the gamma detector assembly and maintaining the gamma detector assembly. For example, the gamma detector assembly may comprise a plurality of NaI crystals coupled to a photomultiplier tube (PMT). The Applicant has discovered that the gamma detector assembly, comprising at least the sodium iodine crystals operatively coupled to the PMTs, may be susceptible to shifting in the recorded gamma spectra, for example by several degrees, when scanning operations are conducted in ambient temperatures that are much higher or lower than 20° C. This observed spectral shift is believed to introduce errors into the determination of peak areas, the calculation of the counts, and the resulting elemental soil analysis for detection of DU contamination. The Applicant concludes that the observed spectral shifts are due to a change in detector gain with changes in temperature. As each scintillation crystal in a detector assembly is slightly different and requires calibration, it would be difficult to obtain a calibration coefficient to account for these changes in detector gain based on changes in temperature.

Because such scanning operations may be conducted in a variety of climates and weather conditions, there may be provided, in some embodiments, a temperature-controlled housing to maintain the gamma detector assembly at a stable temperature, to thereby reduce or eliminate the impact of ambient temperature fluctuations on the detector gain.

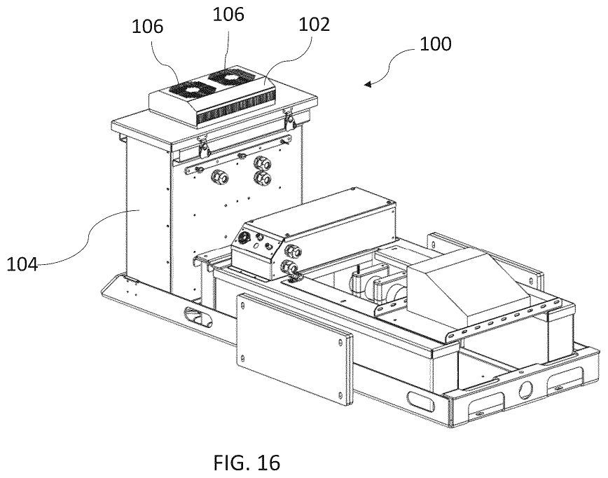

In some embodiments, such as shown in FIG. 16, a mobile MGA system 100, which may be mounted to a cart (not shown), comprises an array of detector assemblies (not shown) housed within a temperature-controlled housing 104. The temperature-controlled housing 104 is provided with a heating and cooling unit 102, which circulates heated or cooled air into the housing 104 via fans 106. The heating and cooling unit 102 may also be provided with a temperature sensor, such as a thermocouple or other sensors as would be known to a person skilled in the art. The temperature sensor may be in electronic communication with an electronic controller of the MGA system. The electronic controller monitors the temperature readings provided by the temperature sensor and controls the heating and cooling unit 102 so as to maintain the temperature within the housing 104 at a pre-determined temperature, within a tight temperature range. For example, not intended to be limiting, the pre-determined temperature of the housing 104 may be set at 20° C., or at 23° C., or at another temperature suitable to reduce or eliminate the impact of temperature fluctuations on the detector gain. If it is desired to maintain a peak stability of +/−1% (in other words, for example, a hydrogen peak having a centroid at 2.22 MeV would be expected to be positioned at 2.22 MeV+/−0.02 MeV), then the temperature within the housing 104 would be maintained at 20° C.+/−0.5° C. On the other hand, if peak stability is required to be maintained at +/−0.5%, then the temperature within the housing would be maintained at 20° C.+/−0.25° C.

In some embodiments, the heating and cooling unit 102 may be configured to maintain the pre-determined temperature when ambient temperature conditions fluctuate in the range between −20° C. and 40° C. In some embodiments, the heating and cooling unit may be provided with only a heater, so that the housing is heated to maintain the pre-determined temperature of, for example, 20° C. in cold weather conditions. In other embodiments, the heating and cooling unit may be provided with only an air conditioning unit, so that the housing is cooled to maintain the pre-determined temperature in hot weather conditions. In some embodiments, the housing 104 may include a double-wall construction and may also include insulation to assist with maintaining the temperature inside the housing at the pre-determined temperature.

### Processing Data from Acquired Gamma Spectra to Detect DU Contamination

In some embodiments of the present disclosure, gamma spectra measurements acquired using an MGA system may be utilized to estimate the location of DU pieces that may be found in a field, such as in a former battlefield where DU munitions were used. This is done by processing the acquired gamma spectra to quantify the counts, associated with the characteristic peaks for the daughter isotope of DU, ^{234m}Pa, which characteristic peaks have centroids at 0.766 and 1.001 MeV.

To acquire a dataset of gamma spectra for detection of DU on a field, the MGA system may be mounted to a mobile cart (or other vehicle), and gamma spectrum measurements may be acquired while operating the MGA system in a scanning mode. For example the gamma spectra and the geographic coordinates may be continually acquired while the MGA system is in constant motion and acquiring gamma spectra data during the scanning operation. At regular time intervals, such as every 15 seconds, a gamma spectrum is recorded by the processor, along with the geographic coordinates of a location referencing mechanism for detecting the set of geographic coordinates of the location where the gamma spectrum is recorded. During data processing, such as by a processor or computer that is onboard the MGA system, the difference between two sequentially recorded gamma spectra, and the counts calculated within the selected energy range for the two sequentially recorded gamma spectra, is calculated and the geographic coordinates of the midpoint location between those two adjacent, sequentially recorded gamma spectra locations, is determined. The resulting differential spectra or differential spectrum (otherwise referred to herein as the “midpoint spectra” or “midpoint spectrum”) are assigned to the corresponding midpoint location. The midpoint spectra may be used to calculate the number of counts within the energy range of interest (ie: around peaks having centroids at 0.766 MeV and 1.001 MeV, in the case of detecting DU contamination in the field). The dataset including these count values and the geographic coordinates of the midpoints may then be used to create contour maps, which assist in identifying the likely location of DU contamination in the field, or to narrow down a smaller section of the field where DU contamination is likely to be found.

In some embodiments, the acquired gamma spectra may be processed by a device, such as a computer having a processor, as follows. After performing spectra shifting procedures (when required, as described herein), the midpoint spectra, as derived from two sequentially recorded spectra for the i-th detector, ΔS_{r,i}(Ch_{new}), are calculated (channel by channel) as:

$$Δ {S}_{r , i} ( {Ch}_{new} ) = {S}_{r + 1 , i} ( {Ch}_{new} ) - {S}_{r , i} ( {Ch}_{new} ) \qquad ( 11 )$$

where S_{r+1,i}(Ch_{new}) and S_{r,i}(Ch_{new}) are the shifted measured gamma spectra for the r+1-th and r-th records (in counts per channel) for i-th detector. (Here and hereafter, all operations performed on the acquired gamma spectra may be performed channel by channel). The differential spectra in cnt/ch (count per channel) per 15 s for each midpoint are summed in accordance with the following equation:

$$Δ {S}_{r} ( {Ch}_{new} ) = {\sum }_{i = 1}^{3} Δ {S}_{r , i} ( {Ch}_{new} ) \qquad ( 12 )$$

The acquired gamma spectra may thereby be correlated to the corresponding geographic coordinates of each midpoint between each pair of adjacent locations where a gamma spectrum was acquired and recorded by the MGA system. These midpoint spectra may then be used for determining the spectra intensity in the range of interest around the peaks 0.766 and 1.001 MeV. In the testing described herein, the MGA system is continuously acquiring data as it moves across the field, and is recording the acquired gamma spectrum and geographic coordinates of the location at the time of measurement and recordal, at regular time intervals (for example, every 15 seconds). A shorter time interval therefore results in a greater number of gamma spectra records, and may therefore result in a higher resolution map, because the gamma spectra are recorded at points that are a shorter distance from each other. However, it will be appreciated that other time intervals for measurement may be used and are intended to be included in the scope of the present disclosure. The resulting dataset, consisting of spectral intensity measurements (counts) and geographic coordinates of midpoints, may then be used for creating the contour maps of the scanned field, as described further below.

### Gamma Spectra of DU Contamination and Minimum Detection Limits

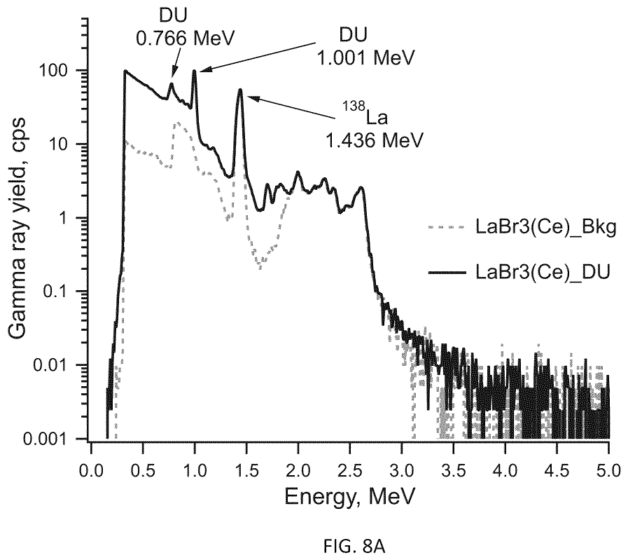

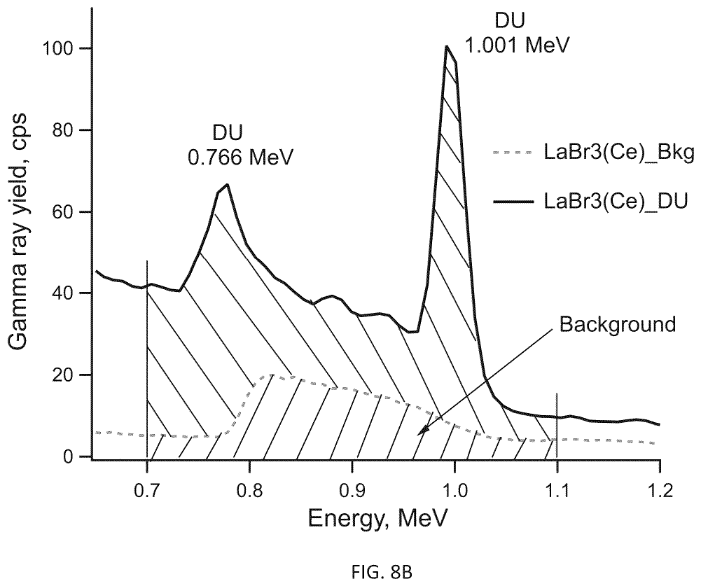

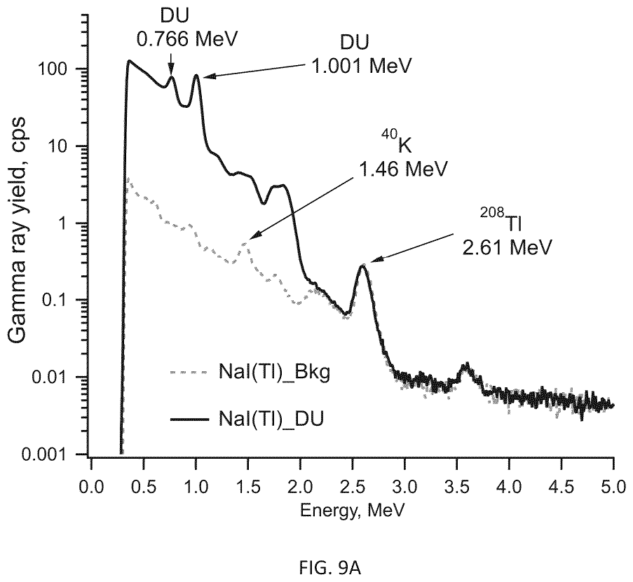

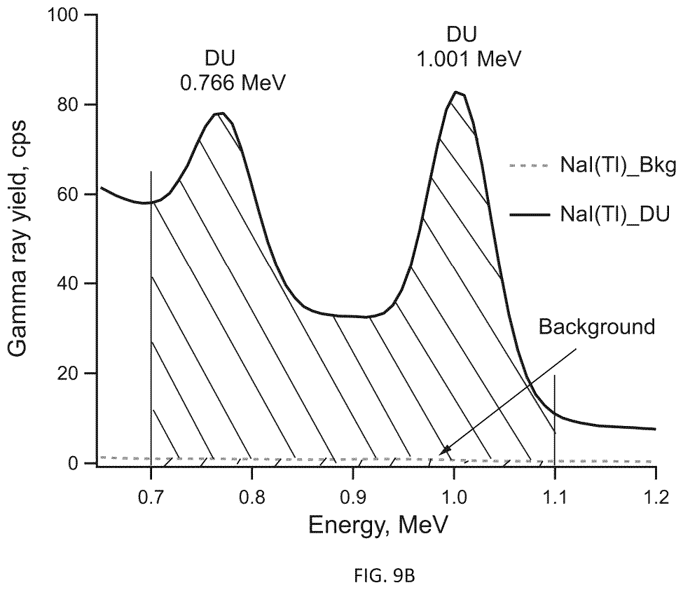

In one example embodiment of the methods described herein, field experiments were conducted to test the methods and systems for detecting DU contamination in a field. In one field experiment, a sample DU block, having the dimensions of 10 cm×10 cm×3 cm and a total weight of 5.95 kg, was utilized. The gamma spectrum of the DU block, taken at a distance of approximately 40 cm from the projection point of the detector assembly, along with a reference background spectra, was taken by two MGA systems; the first MGA system contained one LaBr₃(Ce) scintillator crystal having a total volume of approximately 1264 cm³, and the second MGA system contained three NaI(Tl) scintillator crystals having a total volume of approximately 7355 cm³. The resulting gamma spectra are shown in FIGS. 8A to 8B and 9A to 9B, respectively. The background spectra measured by NaI(TI) system represented the natural background gamma spectra with a set of well-known peaks (²⁰⁸Tl with centroid at 2.61 MeV, ⁴⁰K with centroid at 1.46 MeV), and multiple peaks from ²¹⁴Bi and ²¹⁴Pb, as best viewed in FIG. 9A.

In contrast, the background spectra measured by the LaBr₃(Ce) system, shown in FIG. 8A, displays peaks caused by the presence of the impurities of ¹³⁸La and ²²⁷Ac, the strongest of which is the ¹³⁸La peak having a centroid 1.436 MeV. Under the measurement conditions described herein for the field experiments, the DU block increased both gamma spectra, acquired by the LaBr₃(Ce) and NaI(Tl) systems respectively, in an energy range of less than ˜2 MeV, and displayed two peaks with centroids located at 0.766 and 1.001 MeV. These peaks can be attributed to the daughter isotope ^{234m}Pa present in the DU block, which peaks may be used to detect the presence of DU contamination in the former battlefield.

Acquired gamma spectra were used to estimate the minimum detection limit of DU, Min_massDU, using both the LaBr₃ and NaI systems as described herein. These estimates of the minimum detection limit were calculated as follows:

$$Min massDU = \frac{2.71 + 4.65 \sqrt{Bkg \cdot 15}}{( cpsDU - Bkg ) \cdot 15} \cdot MassDU \qquad ( 13 )$$

where MassDU=5.95 kg (that is, the mass of the DU block used in the field tests described herein), and cpsDU and Bkg are the total count rates in the energy range around the characteristic DU peaks at 0.766 and 1.001 MeV (calculated within an energy range interval of 0.65-1.1 MeV in the acquired spectra), for both the DU spectra and the background spectra, respectively. These calculations were performed for a measurement time interval of 15 s. Calculation results are presented in Table 1, below. It will be appreciated that extending the energy range for the minimum detection limit calculation (ie: an energy range interval of 0.65-1.1 MeV), does not affect the calculated value of the minimum detectable amount of DU.

TABLE 1
Calculated Minimum Detection Limits of DU for 15 second measurement
intervals by LaBr₃(Ce) and NaI(TI) detector assemblies

| | |
|---|---|
| | Counts number in range |
| Total | 0.65-1.1 MeV |

| | volume of | | In | Minimum |
|---|---|---|---|---|
| | scintillator | In | spectrum | Detection |
| Type of | crystal, | background | of DU | Limit of |
| detector | cm³ | spectrum | (5.95 kg) | DU, kg |
| LaBr₃ | 1264 | 7560 | 30705 | 0.105 |
| (Ce) | | | | |
| NaI(TI) | 7355 | 708 | 40200 | 0.019 |

As shown in the data of Table 1, the calculated minimum detection limit of DU by the NaI(Tl) detector assembly is approximately six (6) times less than the calculated minimum detection limit of DU as measured by the LaBr₃(Ce) detector assembly. The light yield of the LaBr₃(Ce) detector assembly (63 photons/keVγ) is higher than for the NaI(Tl) detectors (38 photons/keVy), which is a result of the larger volume of the NaI(Tl) detectors (which are approximately ˜5.8 times larger by volume than the LaBr₃(Ce) detector), and may also be due to the decreased value of the measured gamma spectra of the background soil in the range of interest. Note that the DU content in various munitions may vary from 180 g in 20 mm projectiles, to 4.5 kg in 120 mm penetrators. Therefore, the gamma detector assembly having three NaI(Tl) scintillation crystals may be a preferred embodiment of the MGA system for DU contamination detection. However, it will be appreciated that the system configured with a gamma detector assembly utilizing a LaBr₃(Ce) detector assembly, or any other suitable gamma detector assembly as would be known to a person skilled in the art, may also be used in the systems and methods described herein for DU contamination detection. Examples of other potentially suitable gamma detectors include, but are not limited to: other scintillation detectors (eg: BGO (Bismuth germanate), CsI(TI), CsI(Na), CeBr3, CaF2(Eu)), and Semiconductive detectors (silicon or germanium).

### Monte Carlo Modelling for Detection Sensitivity

When DU ordinances are used in battle. DU may be dispersed as small fragments and mixtures of fine particles and acrosols in the soil, in the vicinity of the impact between a DU ordinance and a hard surface. The position of the detector, relative to the location of the DU in the soil, will impact whether radiation emitted by the DU will be detected by the detector assembly of the MGA system. There are two factors affecting the sensitivity of the detector assembly to pick up a signal from the DU in the soil: a) the soil depth of the DU; and b) the lateral distance between the DU and the center line of the detector assembly. Modelling was performed to estimate the sensitivity of the system utilizing the NaI(Tl) detector assembly, to find distributed DU in soil at different depths and lateral distances from the detector assembly.

Firstly, the volume of soil containing distributed DU contamination that contributes to the measured gamma spectrum was estimated. The dependence of the count rate in the gamma spectrum (within the 0.65-1.1 MeV energy range), with DU contamination at different soil depths, was investigated through simulations using the Monte Carlo N-Particle Transport (MCNP) software program and experimentally in the field.

Spectral measurements in the field were conducted by burying a DU block directly beneath the gamma detectors (ie: with a lateral distance of 0 cm between the DU block and the projection point of the detector). In the MCNP simulation, a gamma source, with a volume equivalent to that of the DU block, was modeled as a ^{234m}Pa source with gamma emission lines at 0.742, 0.766, and 1.001 MeV, having relative intensities of 0.1066, 0.317, and 0.842, respectively.

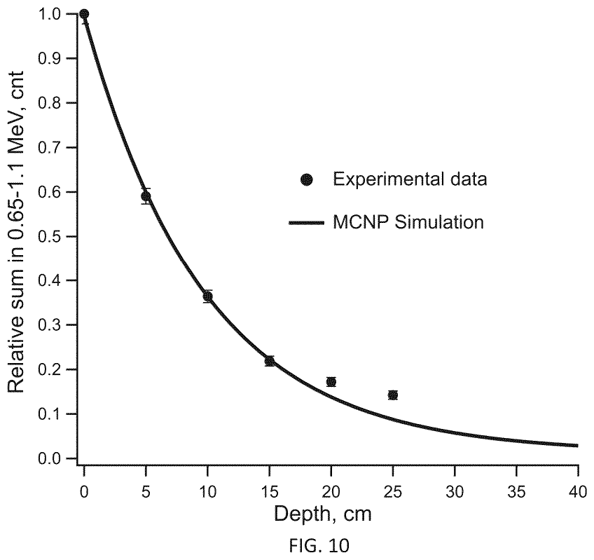

Data from the MCNP simulation (represented by the plot line in FIG. 10) and experimental data obtained from spectral measurements in the field (represented by the data points in FIG. 10) were expressed as dependencies of the counts (cnt) versus depth and were normalized to total counts in the 0.65-1.1 MeV range at a zero-burial depth. As shown in FIG. 10, good agreement was observed between experimental and simulated data. A depth of ˜30 cm may be, in some embodiments, considered the maximum depth from which gamma rays from DU can reach the detector assembly of the MGA system. Thus, in some embodiments of the present disclosure, a surface layer of a soil in which DU contamination may be detected has a depth of approximately 30 cm. However, it will be appreciated that this is not intended to be limiting; for example, DU contamination may be detected in a surface layer of a soil having a depth of greater than 30 cm, for example where an MGA system may be configured with a more sensitive gamma detector assembly and/or where the scanning operation is performed at a slower speed, allowing more time for gamma rays emitted by radioactive substances buried at greater soil depths. However, in many practical applications, a maximum soil depth of 30 cm at which DU contamination may be detected will be sufficient.

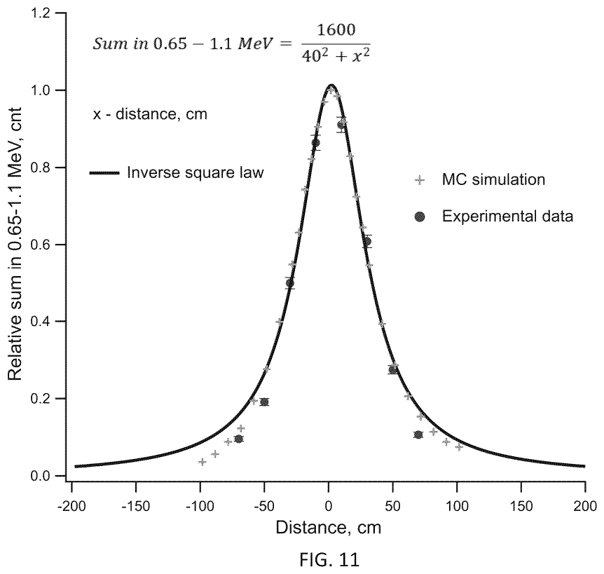

Secondly, spectral measurements in the field were taken of a DU block placed on the soil surface, at various lateral distances from the detector's projection point. This experiment was also simulated using the MCNP software program, wherein the DU block was modelled as a ^{234m}Pa source with the same volume and density as the DU block used in the field, and with the other parameters of the ^{234m}Pa source as were used in the MCNP modelling of the spectral measurements taken at different soil depths described above. Results of both the field measurements and the simulations are shown in FIG. 11, plotting the sum of counts in the 0.65-1.1 MeV energy range of the gamma spectrum versus distance from the projection point of the detector assembly. Along with the fitted curve following the inverse square law, and experimental data, these results were all normalized to the maximum value obtained at zero distance between the detector's projection point and the DU block. As can be seen in FIG. 11, the MCNP simulated data points, the field measurement data points and the fitted curve are all in close agreement. Thus, gamma signal dependence on lateral distance between the projection point of the detector assembly and the DU source location follows the expected inverse square law.

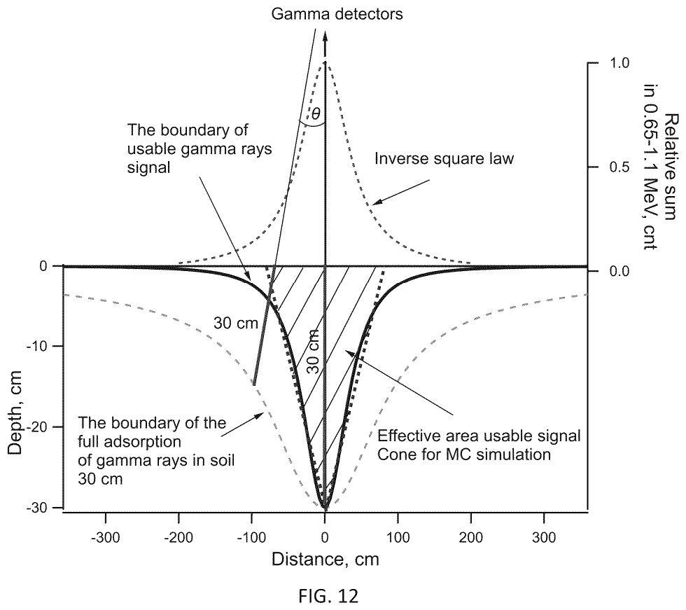

Thirdly, the volume of soil from which gamma rays can reach the surface is limited by the region where the distance to the soil surface (in the direction of the gamma detector) was modelled, by combining the results of the lateral distance modelling and field spectral measurements, and the results of the soil depth modelling and field spectra measurements described above. The profile of the central cross-section of this volume of soil can be described as:

$$Y = 30 \cdot cos ( θ ) , \qquad ( 14 )$$

$$X = ( \frac{40}{cos ( θ )} + 30 ) \cdot sin ( θ ) . \qquad ( 15 )$$

where X and Y are coordinates of the soil volume profile shown in FIG. 12, 40 (cm) is the height of the detector position above the soil surface, 30 (cm) is the maximum depth of a source in the soil, beyond which depth a full attenuation of gamma rays in the soil may occur, and θ is the angle shown in FIG. 12. As shown in FIG. 12, an approximately conical volume of soil defines the boundary, beyond which boundary it is estimated that full attenuation of the gamma rays emitted by a source would occur. In other words, the soil located within the boundary shown in FIG. 12 defines the conical volume of soil from which usable gamma rays may be emitted and received by the detector assembly. The projection of the central cross-section profile on the inverse square law provides the boundary of soil volume associated with the gamma spectra. This boundary curve is represented by the bold black plot line shown in FIG. 12. For simplifying the following steps, the effective soil volume for gamma ray acquisition was approximated by a conical cross section, with a height of 30 cm and a base diameter of ˜190 cm, represented by the dashed plot line in FIG. 12.

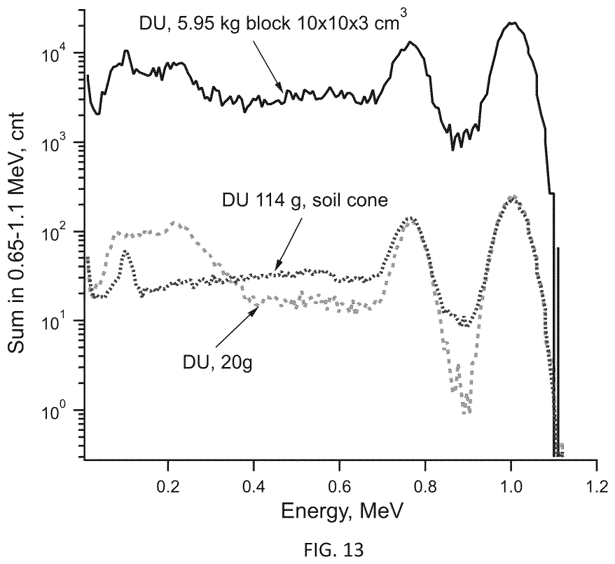

Activity, A_{Pa}, of the ^{234m}Pa in the DU block (5.95 kg) can be calculated as

$${A}_{P a} = 0.9 \cdot {λ}_{U} \cdot {N}_{U} = \frac{0.9 \cdot {λ}_{U} \cdot {m}_{U} \cdot {N}_{A v}}{{Aw}_{U}} = 6.7 \cdot {10}^{7} Bq , \qquad ( 16 )$$

where λ_{U}=4.92·10⁻¹⁸ s, representing the decay constant of ²³⁸U, m_{U}=5950 g, representing the mass of the DU block used in the field experiments, N_{Av}==6.022·10²³ mol⁻¹(the Avogadro number), Aw_{U}=238 Da, which is the atomic weight of DU (mainly comprising ²³⁸U), and 0.9 is a multiplier representing the 90% equilibrium of ^{234m}Pa decay with ²³⁸U decay in DU. The minimal detectible weight of DU for the system utilizing the NaI(Tl) detector assembly may be estimated as approximately 20 g (see Table 1). Given that the activity of ^{234m}Pa will be 2.2·10⁵ Bq, the gamma spectra of a 20 g DU fragment may be detected by the system utilizing the NaI(Tl) detector assembly. The simulated gamma spectra of a DU block and a 20 g DU fragment, each having the aforementioned ^{234m}Pa activity, are shown in FIG. 13. Similarly, the DU fragment spectrum will provide a conical soil volume (having a height of 30 cm and a base diameter of 190 cm; total volume of the conical soil volume being approximately 283,530 cm³) which contains 1.3·10⁶ Bq of ^{234m}Pa as per the MCNP simulation, also shown in FIG. 12.

As described herein, when a DU munition impacts a hard target, a percentage of the DU will be dispersed into the soil, meaning that the DU is pulverized into tiny particles or dust. When DU is dispersed into the soil, the gamma rays emitted are also dispersed, so that fewer gamma rays are being detected by the gamma detector assembly, in the same way as moving the placement of the DU fragment affected detection (see FIG. 12). With dispersion, some of the DU may be in an ideal position to produce gamma rays for detection by the gamma detector assembly, and other portions of the DU will have limited impact on the overall gamma radiation detected by the gamma detector assembly. As a result, with dispersion, an increased amount of DU present in the soil is required for effective detection. Monte Carlo simulations were conducted to determine the MDL from dispersed DU, and the results indicated that the mass of dispersed DU in soil which will have such activity will be equal to 114 g, and the soil DU concentration (density of ˜1.4 g/cm³) may be estimated as 0.4 mg U/cm³ or ˜286 mg U/kg. This MDL of the dispersed DU content in the soil may be detected by the system configured with the NaI(Tl) detector assembly as described herein. Note that DU concentrations in soil samples from former battlefields varied from a few milligrams U per kg of soil, up to ˜18 g per kg of soil. Thus, these findings indicate that the described system configured with the NaI(Tl) detector assembly may be practically used for detection of DU contamination in a field.

### Field Test—Detecting a Sample of DU Hidden in a Field Using an NaI(Tl) Detector Assembly

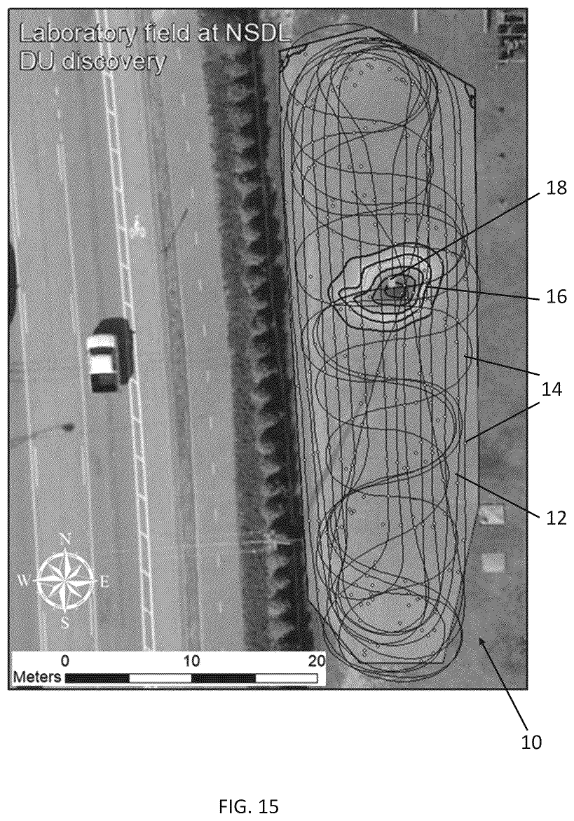

To test the systems and methods described herein, the MGA system utilizing the NaI(Tl) detector assembly was used to carry out an experiment to identify the location of the 5.95 kg block of DU hidden in a laboratory field, the laboratory field having dimensions of 12 m by 50 m. The DU block was buried so that the layer of soil on top of the block was not more than 0.5 cm. The MGA system was moved across the field in a scanning mode, with an average speed 1.4 km/h (˜0.4 m/s). The duration of the scanning survey was approximately 55 min and the total distance travelled across the field was approximately 1.3 km. The laboratory field 10 and the survey path 12 of the MGA system are shown in FIG. 15, with the midpoints 14 between two adjacent locations where a gamma spectrum was acquired are denoted by a white dot. The survey path 12 was devised to approximately uniformly cover the surveyed field 10. Each gamma spectrum of the plurality of gamma spectra was acquired and recorded every 15 seconds. The total number of gamma spectrum records was 218. As was mentioned above, the midpoints spectra were calculated as a difference between neighboring, adjacent spectra, and associated with each midpoint location. The number of counts, for each calculated midpoint spectrum, was determined within a range between 0.65 and 1.1 MeV, which energy range encompasses the characteristic peaks of DU (ie: the daughter isotope ^{234m}Pa), having peak centroids at 0.766 and 1.001 MeV.

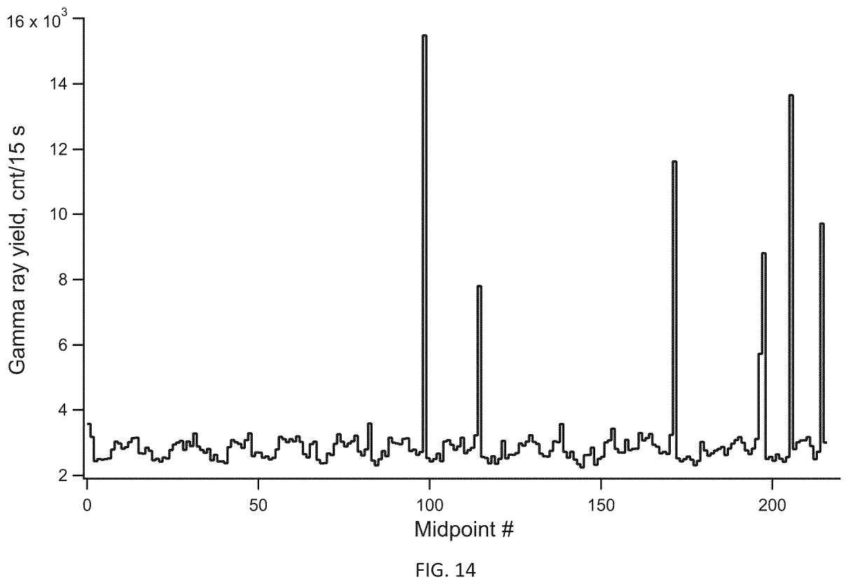

The value of counts determined in each midpoint spectrum for each midpoint are represented in the graph of FIG. 14, with the X-axis denoting the midpoint locations numbered 1 to 218. As may be viewed in FIG. 14, for many of the midpoints, the counts were approximately 3000 and coincided with the number of counts in this range for the natural background spectrum of the soil. However, at several midpoints, the value of the number of counts increased dramatically, and some reached approximately 15,000 counts. These spikes correlate to the locations of midpoints where gamma spectra were acquired nearby the hidden block of DU. Thus, in FIG. 15, the contour lines 16 denote the areas on the map where the calculated counts, calculated within the energy range of 0.65-1.1 MeV, were found to be above the threshold, background spectra counts of approximately 3,000.

The data set of the number of counts in the range 0.65-1.1 MeV for each midpoint spectra, and geographic coordinates of each midpoint spectra, were used for creating the map of DU distribution over the field shown in FIG. 15. Datasets were downloaded into a mapping software, such as the ArcMap™ software, and the Local Polynomial Interpolation method (Polynomial 5 kernel function) was used to create maps overlying the geographic base map. As shown in FIG. 15, contour lines 16 indicate the regions with increased DU content, and block 18 represents the actual location of the hidden block of DU position in the field. As can be seen, the contour lines showing the areas of increased counts in the range of 0.65 to 1.1 MeV, indicating the presence of DU, narrows down the area where DU is more likely to be found within the field that is surveyed. The diameter of the central contour line is around 1.5 meters.

The exact position (±1-3 cm) of the DU block, within the contour lines on the generated map, may be found by any suitable means for locating DU. In some embodiments, a meter with a Gaiger-Muller gauge, for instance the Extended Reach microR™ Survey Meter™, Model 3006. Note the position of the DU block 18 practically coincides with the center of the contour lines 16. In other embodiments, intensive sampling of the smaller area identified as the probable location of DU contamination may be undertaken, or alternatively, a high resolution scanning survey may be conducted of the smaller area, otherwise referred to herein as an area of probable contamination, in which 100% of the surface area of the field identified as near the probable location of DU contamination, may be performed.

In conclusion, the methods and systems disclosed herein may be used to locate pieces of DU that are buried within a field within a relatively quick period of time; for example, scanning the field in the field experiment described herein took less than one hour to complete, and there was sufficient information provided to identify the location of the hidden DU block within a 1.5 m radius on a field measuring 12 m by 50 m. As well, the minimum detection limit for a piece of DU is approximately 20 grams, when utilizing a system having gamma detectors comprising a set of three NaI(Tl) scintillation crystals having a total volume of approximately 7.4 L. However, as will be appreciated by a person skilled in the art, any other suitable gamma detector assembly which is capable of measuring gamma radiation produced by U, may be utilized in an MGA system and such detector assemblies are intended to be included in the present disclosure.

According to the systems and methods disclosed herein, an MGA system configured with a suitable gamma detector assembly, as would be known to a person skilled in the art, may be moved across a field in scanning mode, for the detection of DU contamination located in a large area, such as a field used for agriculture. Such systems and methods may, in some embodiments, detect a fragment of DU that is 20 g or larger, and/or DU dispersed into the soil at a concentration of 0.4 mg U/cm³ or greater, and may identify the location of the DU within a relatively small area. In the tests conducted herein, the scanning mode was configured to acquire gamma spectra at 15 s time intervals, together with the geographic coordinates of the position on the field where each gamma spectrum was recorded. The resulting data set, comprising the geographic coordinates and the number of counts in each midpoint spectra, calculated within a given energy range that encompasses the characteristic gamma peaks with centroids located at 0.766 and 1.001 MeV, may be used to create a distribution map of these counts acquired across a field, providing for the visual identification of the location of DU contamination in the field.

In some embodiments of the present disclosure, the MGA system does not need to provide a precise measurement of the quantity of DU in a contaminated soil. In some embodiments, the goal is to identify areas in a field where DU contamination is present in a relatively quick and inexpensive manner. This may be accomplished by identifying locations in a field where distinct spikes in the number of counts, calculated from a midpoint spectra in a given energy range that encompasses peak centroids that are characteristic of DU and which exceed the background levels of uranium naturally present in the soil. Once identified, other tests may be performed on the identified areas of probable DU contamination to accurately locate and quantify the level of DU contamination and determine an appropriate remediation plan, using techniques to quantify the DU present in the field as would be known to a person skilled in the art. In some cases, an area in a field where substantial DU contamination has been confirmed may not be used for agricultural purposes until satisfactory remediation has occurred.

In other embodiments of the present disclosure, it may not be desirable or practical to plan a survey path that covers nearly 100% of the surface area of the field or a large proportion of the field. In such embodiments, a smaller percentage of the total surface area of the field (such as 50% or less of the surface area of the field) may be scanned in an initial pass, and if there are no spikes detected within the relevant energy range of the midpoint spectra obtained from the initial pass scan, then large areas of the field may be eliminated as potentially containing DU contamination. Depending on the distance between the horizontal and vertical lines of a scanning grid or path, if such horizontal and vertical lines may be, for example, several meters apart from one another. In such a low resolution scan, it is possible that isolated fragments of DU, weighing approximately 20 g or less, may not be detected. However, if an initial, low-resolution scan of a large field (for example, 100 acers or more) is performed, it should be noted that small and isolated fragments of DU that may be present in the soil that may be missed in such a scan, do not present a health or environmental hazard. On the other hand, where one or more midpoints produce a spike within the relevant energy range of the midpoint spectra obtained from the initial low-resolution scan, then more intensive scanning may be performed in order to more precisely identify the location of the DU contamination in the field. Alternatively, once areas of probable DU contamination have been identified through an initial scan of a large field, these areas of probable DU contamination may be surveyed in greater detail, such as by using an intensive sampling regime to obtain samples and perform a laboratory analysis to detect the presence of DU, or by using a Gaiger-Muller gauge to perform a survey of the areas of probable DU contamination.

What is claimed is:

1. A method for detecting depleted uranium contamination in a surface layer of soil in a geographic area, the method comprising:
moving a system mounted to a mobile platform across the geographic area, the system for acquiring a gamma spectrum at each location of a plurality of locations across the geographic area, the system comprising:
a gamma detector assembly for detecting a gamma spectrum of the surface layer of the soil at each location,
a location referencing mechanism for detecting a set of geographic coordinates of each location,
a processor in communication with the detector assembly and the location referencing mechanism, the processor configured to:
record each gamma spectrum and the corresponding set of geographic coordinates of each location where the gamma spectrum was recorded;
calculate a midpoint spectrum between two sequential locations of the plurality of locations,
calculate a number of counts for an energy range of each midpoint spectrum, each calculated number of counts associated with a midpoint location, the midpoint location located midway between the said two sequential locations,
compare the calculated number of counts for each midpoint location to a threshold number of counts, the threshold number of counts representing a number of counts for the energy range of a background gamma spectrum of the surface layer of soil, wherein when the calculated number of counts exceeds the threshold number of counts the midpoint location is identified as a location of probable contamination.

2. The method of claim 1 wherein the gamma detector assembly is selected from a group comprising: bismuth germanate scintillation detector assembly, CsI(Tl) scintillation gamma detector assembly, CsI(Na) scintillation gamma detector assembly, LaBr₃(Ce) scintillation gamma detector assembly, CaF2(Eu) scintillation gamma detector assembly, silicon semiconductive gamma detector assembly, germanium semiconductive gamma detector assembly.

3. The method of claim 1 wherein the energy range is selected to encompass at least one characteristic peak of a daughter isotope of uranium in a gamma spectrum of the daughter isotope.

4. The method of claim 3 wherein the daughter isotope is ^{234m}Pa and the at least one characteristic peak comprises two characteristic peaks having centroids at 0.766 MeV and 1.001 MeV.

5. The method of claim 4 wherein the energy range is from 0.65 MeV to 1.1 MeV.

6. The method of claim 1 wherein the method further comprises a step of generating a map of the geographic area, the map displaying one or more locations of probable contamination.

7. The method of claim 6 wherein the map includes one or more contour lines, each contour line of the one or more contour lines defining one or more areas of probable contamination, each area of probable contamination encompassing one or more locations of probable contamination.

8. The method of claim 7 wherein the method further comprises a step of surveying each area of the one or more areas of probable contamination to identify locations of depleted uranium contamination.

9. The method of claim 8 wherein the step of moving the system for acquiring the gamma spectrum at each location of a plurality of locations across the geographic area comprises performing a low resolution scan of the geographic area with the system, and wherein the step of surveying each area of the one or more areas of probable contamination comprises performing a high resolution scan of each area of the one or more areas of probable contamination.

10. The method of claim 8 wherein the step of surveying each area of the one or more areas of probable contamination is selected from a group comprising: performing intensive sampling and laboratory analysis of each area, performing a search of each area using a meter with a Gaiger-Muller gauge.

11. The method of claim 9 wherein the low resolution scan of the geographic area consists of scanning 50% or less of a total surface area of the geographic area, and wherein the high resolution scan consists of scanning 51% or more of a total surface area of the one or more areas of probable contamination.

12. The method of claim 11 wherein the low resolution scan of the geographic area consists of scanning 5% to 50% of the total surface area of the geographic area, and wherein the high resolution scan consists of scanning 70% to 100% of the total surface area of the one or more areas of probable contamination.

13. The method of claim 1 wherein the gamma detector assembly comprises one or more scintillation crystals.

14. The method of claim 13 wherein the one or more scintillation crystals comprises at least two scintillation crystals, and wherein the processor is further configured to calibrate an energy of each recorded gamma spectrum detected by each scintillation crystal of the at least two scintillation crystals prior to the step of calculating a midpoint spectrum between two sequential locations of the plurality of locations.

15. The method of claim 14 wherein the at least two scintillation crystals consists of three NaI(Tl) crystals having a total volume of more than 7 liters.

16. The method of claim 1 wherein the location referencing mechanism is a Global Positioning System (GPS).

17. A system for detecting depleted uranium contamination in a surface layer of soil in a geographic area, the system comprising:
a gamma detector assembly for detecting a gamma spectrum of the surface layer of the soil at each location,
a location referencing mechanism for detecting a set of geographic coordinates of each location,
a processor in communication with the detector assembly and the location referencing mechanism, the processor configured to:
record each gamma spectrum and the corresponding set of geographic coordinates of each location where the gamma spectrum was recorded;
calculate a midpoint spectrum between two sequential locations of the plurality of locations,
calculate a number of counts for an energy range of each midpoint spectrum, each calculated number of counts associated with a midpoint location, the midpoint location located midway between the said two sequential locations,
compare the calculated number of counts for each midpoint location to a threshold number of counts, the threshold number of counts representing a number of counts for the energy range of a background gamma spectrum of the surface layer of soil, wherein when the calculated number of counts exceeds the threshold number of counts the midpoint location is identified as a location of probable contamination.

18. The system of claim 17 wherein the gamma detector assembly is selected from a group comprising: bismuth germanate scintillation detector assembly, CsI(Tl) scintillation gamma detector assembly, CsI(Na) scintillation gamma detector assembly, LaBr₃(Ce) scintillation gamma detector assembly, CaF2(Eu) scintillation gamma detector assembly, silicon semiconductive gamma detector assembly, germanium semiconductive gamma detector assembly.

19. The method of claim 17 wherein the energy range is selected to encompass at least one characteristic peak of a daughter isotope of uranium in a gamma spectrum of the daughter isotope.

20. The system of claim 19 wherein the daughter isotope is ^{234m}Pa and the at least one characteristic peak comprises two characteristic peaks having centroids at 0.766 MeV and 1.001 MeV.

21. The system of claim 20 wherein the energy range is from 0.65 MeV to 1.1 MeV.

22. The system of claim 17 wherein the processor is further configured to generate a map of the geographic area, the map displaying one or more locations of probable contamination.

23. The system of claim 22 wherein the map includes one or more contour lines, each contour line of the one or more contour lines defining one or more areas of probable contamination, each area of probable contamination encompassing one or more locations of probable contamination.

24. The system of claim 17 wherein the gamma detector assembly comprises one or more scintillation crystals.

25. The system of claim 24 wherein the one or more scintillation crystals comprises at least two scintillation crystals, and wherein the processor is further configured to calibrate an energy of each recorded gamma spectrum detected by each scintillation crystal of the at least two scintillation crystals prior to the step of calculating a midpoint spectrum between two sequential locations of the plurality of locations.

26. The system of claim 25 wherein the at least two scintillation crystals consists of three NaI(Tl) crystals having a total volume of more than 7 liters.

27. The system of claim 17 wherein the location referencing mechanism is a Global Positioning System (GPS).

28. The system of claim 24 wherein the gamma detector assembly is housed within a temperature-controlled housing to maintain the gamma detector assembly at a set temperature when performing a scanning operation.
